(19) United States
(12) Patent Application Publication
(10) Pub. No.: US 2007/0169892 A1
(43) Pub. Date: Jul. 26, 2007

(54) Box sealing machine capable of automatically detecting adhesive tape

(76) Inventor: Tuan-Mei Chiu Chen, Ta-Lin Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/335,652

(22) Filed: Jan. 20, 2006

(51) Int. Cl. B32B 37/00; B32B 41/00

(52) U.S. Cl. 156/360; 156/361; 156/363; 156/378

(57) ABSTRACT

A box sealing machine includes a bed, a conveying platform on the bed for conveying goods, a supporting member joined to the bed and adjustable in height, a tape applying mechanism fitted on the supporting member, and a response detecting device; the tape applying mechanism includes a tape stand, a tape roll supported on the tape stand, a cutter for severing the tape, and several supporting rollers, over which a free section of the tape roll is passed; one of the supporting rollers has a responding element fitted thereon; the response detecting device is used for sensing the responding element to monitor rotation of the supporting rollers such that warning signals will be sent out if abnormal conditions are detected when the tape is being applied onto openings of goods.

### BACKGROUND OF THE INVENTION

1. Field of the invention

The present invention relates to a box sealing machine capable of automatically detecting adhesive tape, more particularly one, which is equipped with a sensor and a response detecting device respectively for detecting height of goods to be sealed and monitoring the tape applying process, and which will send out warning signals or stop working if abnormal conditions happen, e.g. the cutter failing to sever the tape, accidental breaking of the tape, and using up the tape.

2. Brief Description of the Prior Art

Opening ends of boxes and other packaging materials are usually closed and fixed by means of adhesive tapes, glue or staples. It takes relatively much time and labor to manually apply adhesive tapes to seal and fix the opening end of a box. Therefore, it is a common practice to seal boxes by means of a box sealing machine.

Referring to FIG. 5, a currently existing box sealing machine 9 includes a bed 91, a conveying platform 92, a conveying belt set 93, a supporting member 94, and a tape applying mechanism 95. The conveying platform 92 is positioned on the bed 91 for conveying goods 96, and it has several rolling wheels (not shown) thereon for helping the goods 96 move. The supporting member 94 is joined to the bed 91, and includes threaded rods 941, guiding parts 942 threadedly engaging respective ones of the threaded rods 941, and a transverse rod 943, which is connected to the guiding parts 942 so as to be movable up and down along the threaded rods 941 together with the guiding parts 942. The tape applying mechanism 95 is positioned on the transverse rod 943 of the supporting member 94, and includes a tape stand 951, and a tape roll 952 supported on the tape stand 951. Furthermore, a second tape applying mechanism (not shown) is fitted under the conveying platform 92 for applying tapes to lower sides of the goods 96. After the transverse rod 943 and the tape applying mechanism 95 are adjusted to a proper height, a section of the tape roll 952 will be applied on the goods 96 when the goods 96 are fed onto the conveying platform 92, and moved forwards by the conveying belt set 93.

However, the above box sealing machine structure has the following disadvantages:

1. The transverse rod of the supporting member and the tape applying mechanism have to be adjusted to a proper height previously before the machine is used to seal goods of a certain height. And, the transverse rod and the tape applying mechanism have to be adjusted in height if the machine is to be used to seal other kinds of goods having different heights from the last ones. Therefore, the machine is inconvenient to use.

2. The machine isn't equipped with an alert system for indicating abnormal situations and emergencies, which need be immediately handled, such as tape breaking, failure to cut the tape, and using up the tape. Consequently, the sealing process will be discontinued by such abnormal situations and emergencies.

3. When abnormal situations happen and need to be handled or the tape roll on the lower tape applying mechanism needs to be changed, the technicians will have trouble performing their tasks in the space between the upper tape applying mechanism and the conveying platform because the space is relatively small. Further, it takes much labor and time to manually turn the threaded rods to raise the transverse rod to its highest position for increasing the space between the upper tape applying mechanism and the conveying platform.

### SUMMARY OF THE INVENTION

It is a main object of the present invention to provide a box sealing machine, which can detect tapes, and adjust the height of the tape applying mechanism automatically to suit goods to be sealed.

It is a second object of the present invention to provide a box sealing machine, which will monitor the amount of tapes used in each tape applying process, and send out alerting signals when abnormal conditions occurs.

The box sealing machine of the present invention includes a bed, a conveying platform on the bed for conveying goods, a supporting member joined to the bed and adjustable in height, a tape applying mechanism fitted on the supporting member, and a response detecting device; the tape applying mechanism includes a tape stand, a tape roll supported on the tape stand, a cutter for severing the tape, and several supporting rollers, over which a free section of the tape roll is passed; one of the supporting rollers has a responding element fitted thereon; the response detecting device is used for sensing the responding element to monitor rotation of the supporting rollers such that warning signals will be sent out if an abnormal condition is detected when the tape is being applied onto goods. The tape stand has a sensor fitted on a lateral side thereof for detecting amount of those portions of the tape roll that have not yet been used; alerting signals will be sent out when the amount of spare portions of the tape roll drops to a predetermined value.

The supporting member includes a lifting device securely joined to the bed at one end, an up and down movable unit joined to other end of the lifting device, and an inverted U shaped unit having a substantially inverted U shaped section. The U shaped unit is fitted on the up and down movable unit, and has plural co-turning threaded rods fitted thereto, which can be turned to move the inverted U shaped unit relative to the up and down movable unit. The conveying platform has front and rear detecting devices at front and rear ends thereof for sensing goods when goods are passed into and out of it. The tape applying mechanism has a sensing switch at one end for finding out the height of goods, thus allowing the up and down movable unit to stop at such a height as to allow a tape to be applied onto the goods.

### BRIEF DESCRIPTION OF THE DRAWINGS

The present invention will be better understood by referring to the accompanying drawings, wherein:

FIG. 1 is a side view of the present invention,

FIG. 2 is a top view of the present invention,

FIG. 3 is a front view of the present invention,

FIG. 4 is a front view of the present invention, gripping a material, and

FIG. 5 is a view of the currently existing box sealing machine.

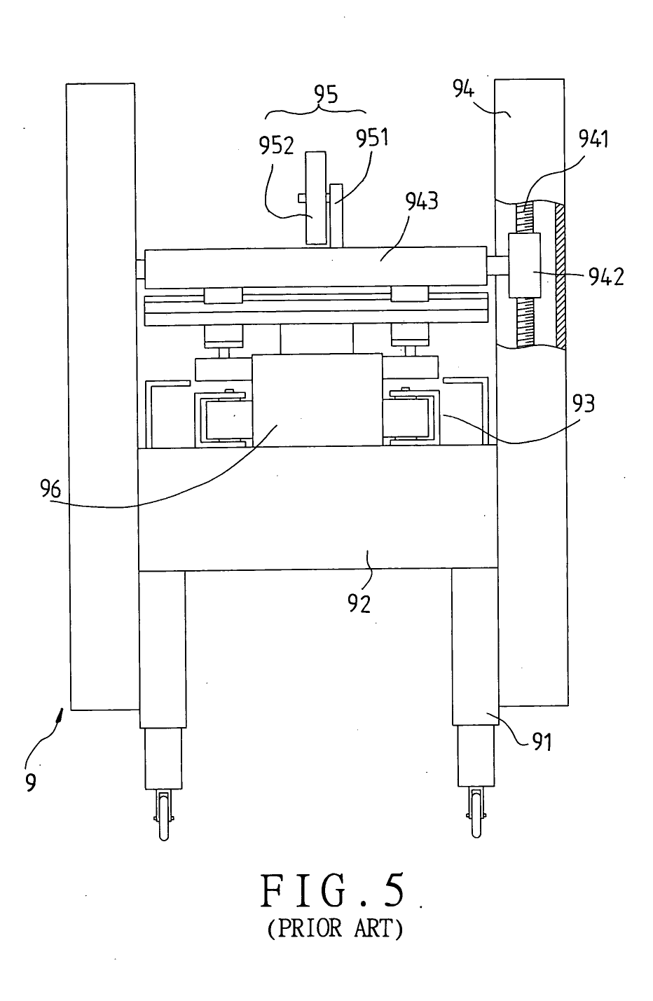

### DETAILED DESCRIPTION OF THE PREFERRED EMBODIMENTS

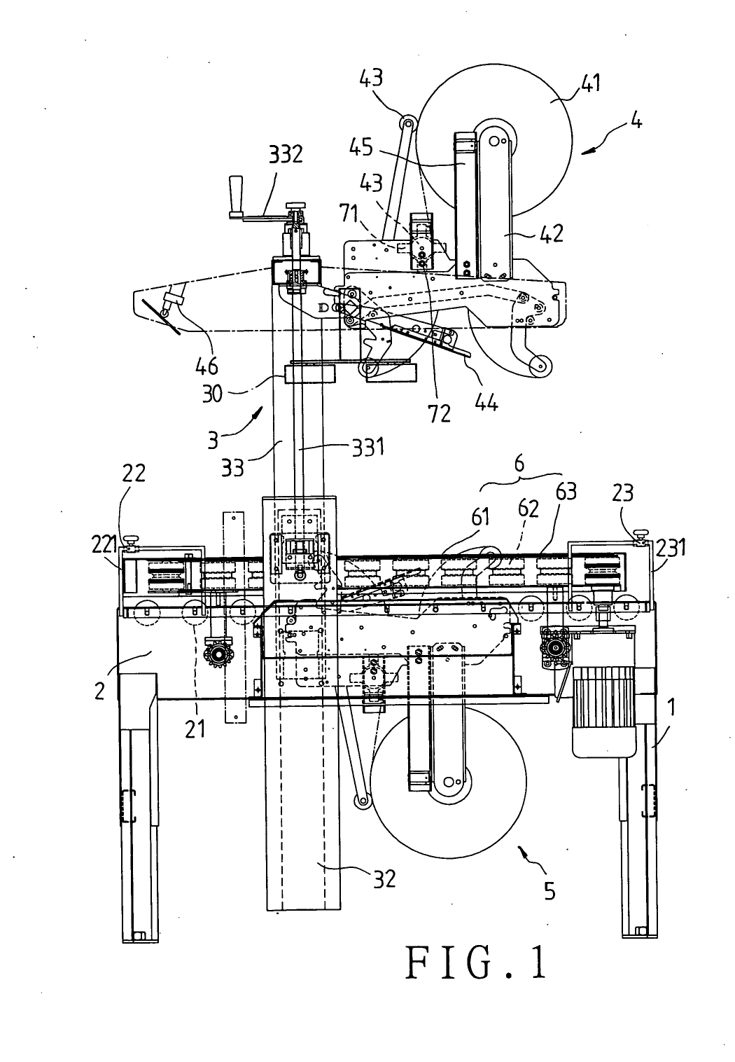

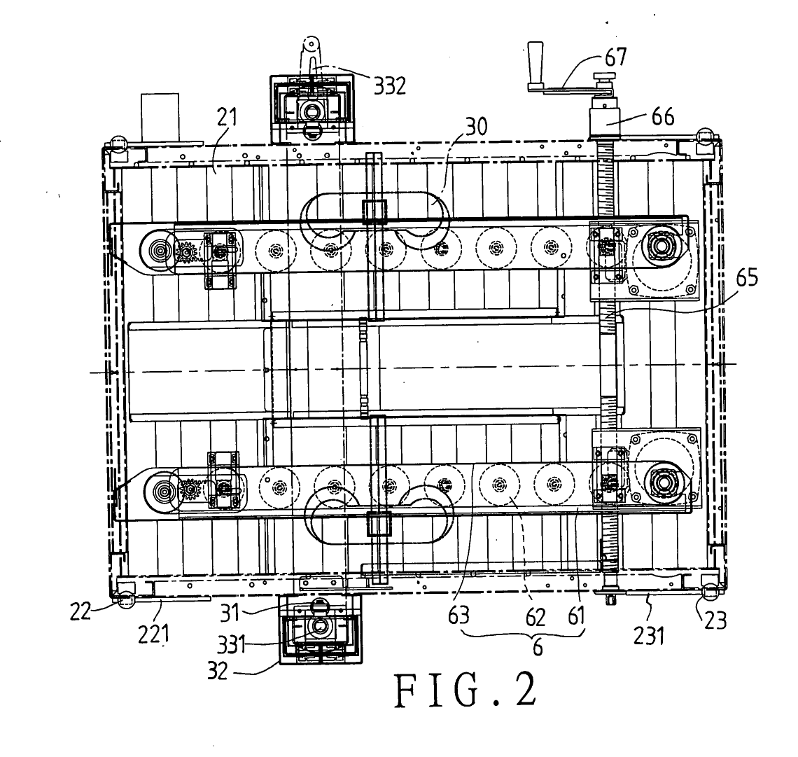

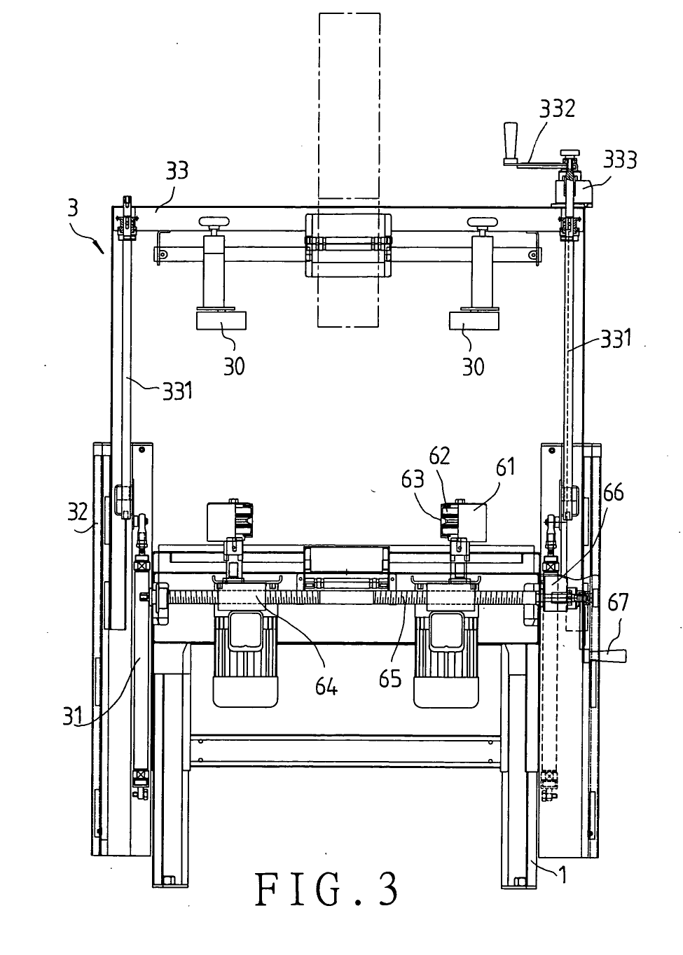

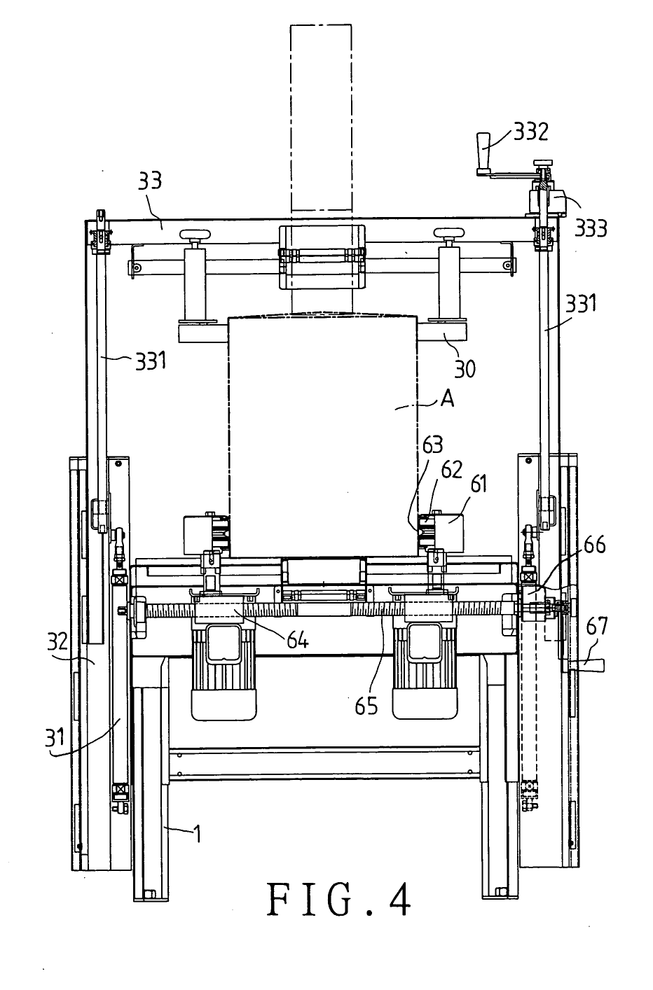

Referring to FIGS. 1 to 4, a preferred embodiment of a box sealing machine in the present invention includes a bed 1, a conveying platform 2, a supporting member 3, an upper tape applying mechanism 4, a lower tape applying mechanism 5, a conveying belt assembly 6, and a response detecting device 72.

The conveying platform 2 is positioned on the bed 1, and it has several rolling wheels 21 thereon, which are used to help move goods (A).

The supporting member 3 is joined to the bed 1 and adjustable in height, and it has two opposed pressing wheel sets 30 joined to a lower side thereof; distance between the opposed pressing wheel sets 30 can be adjusted; when goods (A) are passed through the space between the two opposed pressing wheel sets 30, the pressing wheel sets 30 will press two lateral sides of goods (A) such that original width and flatness of goods (A) remain, and tapes will be smooth and pleasant-looking when applied on goods (A).

Further, the supporting member 3 includes a telescopic lifting device 31, an up and down movable unit 32, and an inverted U shaped unit 33, which has a substantially inverted U shaped section; the telescopic lifting device 31 is securely joined to the bed 1 at one end, and securely joined to the up and down movable unit 32 at the other end; the inverted U shaped unit 33 is fitted on the up and down movable unit 32, and two co-turning threaded rods 331 are fitted to respective ones of two lateral sides of the inverted U shaped unit 33, and a manual height adjusting wheel 332 is joined to an upper end of a first one of the two co-turning threaded rods 331 such that the two co-turning threaded rods 331 can be turned to move the inverted U shaped unit 33 relative to the up and down movable unit 32 by means of turning the manual height adjusting wheel 332; a height meter 333 is joined to a lower side of the manual height adjusting wheel 332 for showing the height of the inverted U shaped unit 33; an electronic control device (not shown) is used to automatically control the length of the telescopic lifting device 31 so as to adjust the height of the up and down movable unit 32 and the inverted U shaped unit 33; the lifting device can be actuated by means of pneumatic pressure or oil hydraulic pressure, and it can include racks and gear set engaging the racks or alternatively it can include chains and transmission gears engaging the chains.

The upper tape applying mechanism 4 is fitted on an upper side of the supporting member 3 for applying tapes onto upper sides of goods (A); the upper tape applying mechanism 4 includes a tape stand 42, a tape roll 41 supported on the tape stand 42, a cutter 44, and several supporting rollers 43, over which a free section of the tape roll 41 is passed; the upper tape applying mechanism 4 is equipped with a sensor 45 on a lateral side of the tape stand 42 for detecting the amount of those portions of the tape roll 41 that have not yet been used; the sensor 45 is faced with a certain position of the tape roll 41 such that it will produce warning light or sound if the amount of spare portions of the tape roll 41 drops to a predetermined value, e.g. one tenth of a completely unused tape roll; the upper tape applying mechanism 4 is further equipped with a sensing switch 46, which is electrically connected to the electronic control device; signals will be sent from the sensing switch 46 to the electronic device for the electronic device to acquire height data of goods (A) on the conveying platform 2 as soon as the sensing switch 46 touches goods (A) during the course of the up and down movable unit 32 moving downwards.

The lower tape applying mechanism 5 is positioned under the conveying platform 2 for applying tapes onto lower sides of goods (A); the lower tape applying mechanism 5 has the same structure as the upper one 4, but it is positioned upside down, in contrast to the upper tape applying mechanism 4.

Furthermore, the electronic control device is equipped with a switch (not shown) for turning on/off the telescopic lifting device 31 of the supporting member 3; the tape applying mechanism 4 will function completely automatically if the telescopic lifting device 31 is turned on; the tape applying mechanism 4 will function semi-automatically if the telescopic lifting device 31 is turned off: after the telescopic lifting device 31 is turned off, height of the inverted U shaped unit 33 can be adjusted, and the height of the upper tape applying mechanism 4 fixed by means of turning the manual height adjusting wheel 332, and this way to adjust the height of the inverted U shaped unit 33 is suitable for use in the condition, in which there are single kind of goods (A) or all goods (A) have the same height; tapes will be applied onto goods (A) as soon as goods (A) are passed through the space under the upper tape applying mechanism 4; further, after the up and down movable unit 32 and the inverted U shaped unit 33 are moved to their highest position by means of controlling the lifting device 31 with the switch, the space between the upper tape applying mechanism 4 and the conveying platform 2 will increase, and in turn it will be easier for technicians to do their tasks such as breakdown repair, maintenance, and changing tape roll.

The conveying belt assembly 6 includes two opposed seat parts 61, several rolling wheels 62 fitted to each of the seat parts 61, and a conveying belt 63 passed around the rolling wheels 62 of each conveying seat 61; the seat parts 61 can be moved to adjust the width of the space between them to suit goods (A) to be conveyed; goods (A) will be pressed between the seat parts 61, and moved along by means of the conveying belts 63, and cause the rolling wheels 21 to turn at the same time; further, the conveying belt assembly 6 is equipped with sleeves 64 on a lower side, which are joined to the seat parts 61, and which are each joined to a threaded rod 65, such that the width of the space between the seat parts 61 can be adjusted by means of turning the threaded rod 65; further, a width meter 66 and a manual adjusting wheel 67 are fitted to one end of the threaded rod 65, which are respectively used for showing the width of the space between the seat parts 61, and for manually turning the threaded rod 65.

The response detecting device 72 is used with a responding element 71 for monitoring rotation of a first one of the supporting rollers 43; the response detecting device 72 is positioned next to one end of the first supporting roller 43; the responding element 71 includes four plate parts, which are circumferentially spaced around and joined to the first supporting roller 72; when the tape is being applied onto goods (A) from the tape roll 41, the supporting rollers 43 will be turned by the tape, the response detecting device 72 will detect the plate parts of the responding element 71 such that the number of times the plate parts pass by the response detecting device 72, and the length of tapes having been applied onto goods (A) are found out.

Furthermore, the conveying platform 2 has front and rear detecting devices 22 and 23 at front and rear ends thereof for sensing goods (A) when goods (A) are passed into and out of it, which detecting devices 22 and 23 are respectively positioned on inverted U shaped rails 221 and 231 so as to be movable forwards and rearwards and adjustable in position. When goods (A) are passed through the front end of the conveying platform 2, the front detecting device 22 will sense goods (A), and the electronic control device will make the up and down movable unit 32 lowered. And, the inverted U shaped unit 33 will stop in position for applying tape as soon as the sensing switch 46 touches the height of goods (A); thus, tapes will be applied onto upper and lower sides of goods (A) from the upper and the lower tape applying mechanisms 4 and 5 when goods (A) move forwards.

When the box sealing machine is working under a normal condition, the tape will, when being applied from the tape roll 41 onto a box, cause the supporting rollers 43 to turn, and the cutter 44 will sever the tape at the end, and the plate parts of the responding element 71 fitted on the first supporting roller 43 will pass by the response detecting device 72, which will sense the plate parts, and the electronic control device will acquire the number of times the plate parts of the responding element 71 pass by the response detecting device 72; the length of a tape section applied on each one of plural boxes having the same size should be fixed. Therefore, the number of times the plate parts of the responding element 71 pass by the response detecting device 72 should be a fixed value in sealing one box. If abnormal conditions occur, e.g. the cutter failing to sever the tape, accidental breaking of the tape, and using up the tape, the actual number of times the plate parts of the responding element 71 pass by the response detecting device 72 will be different from the normal value, and the electronic control device will send out warning signals or stop the machine. For instance, the actual number of times the plate parts of the responding element 71 pass by the response detecting device 72 will be smaller than the normal value if the tape breaks accidentally. And, the actual number of times the plate parts of the responding element 71 pass by the response detecting device 72 will be smaller than the normal value if the cutter 44 fails to sever the tape at the end. Therefore, the machine will stop working or send out warning signals until the abnormal conditions are handled; thus, the technicians can notice and handle the abnormal conditions.

From the above description, it can be seen that the present invention has the following advantages:

1. The present invention has the switch for turning on/off the lifting device of the supporting member; if goods to be sealed have the same height, the lifting device is turned off such that the tape applying mechanism is fixed in a certain position, saving the time spent in moving the tape applying mechanism up and down by means of the lifting device; if goods to be sealed have different heights, the lifting device is turned on such that the tape applying mechanism is automatically moved to a proper height each time one of the goods is fed for a tape applying process, of which the height will be found out by means of the sensing switch.

2. The response detecting device will monitor rotation of the supporting rollers for the tape by means of detecting the responding element fitted on one of the supporting rollers, thus helping find out abnormal conditions; the machine will stop working or send out warning signals until the abnormal conditions are handled.

3. The up and down movable unit and the inverted U shaped unit can be moved to their highest position by means of controlling the lifting device with the switch. Therefore, the space between the upper tape applying mechanism and the conveying platform increases, and in turn the present invention is more convenient to use than the prior art; it will be easier for technicians to do their tasks such as breakdown repair, maintenance, and changing the lower tape roll.

What is claimed is:

1. A box sealing machine capable of automatically detecting adhesive tape, comprising
a bed;
a conveying platform on the bed for conveying goods;
a supporting member joined to the bed and adjustable in height;
a tape applying mechanism fitted on the supporting member; the tape applying mechanism including a tape stand, a tape roll supported on the tape stand, a cutter for severing the tape, and a plurality of supporting rollers, over which a free section of the tape roll is passed; at least one of the supporting rollers having a responding element fitted thereon; and
a response detecting device for sensing the responding element to monitor rotation of the supporting rollers, thus calculating number of circles the supporting rollers are turned when a section of tape is being fed from the tape roll and causing the supporting rollers to turn.

2. The box sealing machine capable of automatically detecting adhesive tape as claimed in claim 1, wherein the supporting member includes:
a lifting device securely joined to the bed at one end;
an up and down movable unit joined to other end of the lifting device; and
an inverted U shaped unit, which has a substantially inverted U shaped section; the U shaped unit being fitted on the up and down movable unit; the inverted U shaped unit having plural co-turning threaded rods fitted thereto; the two co-turning threaded rods being capable of being turned to move the inverted U shaped- unit relative to the up and down movable unit;
the conveying platform having front and rear detecting devices at front and rear ends thereof for sensing goods when goods are passed into and out of it;
the tape applying mechanism being equipped with a sensing switch at one end for finding out height of goods; the sensing switch detecting height of goods when the goods are passed by and sensed with the front detecting device, thus allowing the up and down movable unit to stop at such a height as to allow a tape to be applied onto the goods.

3. The box sealing machine capable of automatically detecting adhesive tape as claimed in claim 2, wherein the front and the rear detecting devices are respectively positioned on inverted U shaped rails so as to be movable forwards and rearwards and adjustable in position.

4. The box sealing machine capable of automatically detecting adhesive tape as claimed in claim 2, wherein the co-turning threaded rods are fitted to two lateral sides of the inverted U shaped unit, and a manual height adjusting wheel is joined to an upper end of a first one of the two co-turning threaded rods, and a height meter is joined to a lower side of the manual height adjusting wheel for showing height of the inverted U shaped unit; rotation of the first co-turning threaded rods being going to cause other ones of the co-turning threaded rods to turn.

5. The box sealing machine capable of automatically detecting adhesive tape as claimed in claim 2, wherein the lifting device is telescopic and actuated by means of pneumatic pressure.

6. The box sealing machine capable of automatically detecting adhesive tape as claimed in claim 2, wherein the lifting device is telescopic, and actuated by means of oil hydraulic pressure.

7. The box sealing machine capable of automatically detecting adhesive tape as claimed in claim 2, wherein the lifting device includes racks and gear set engaging the racks.

8. The box sealing machine capable of automatically detecting adhesive tape as claimed in claim 2, wherein the lifting device includes chains and transmission gears engaging the chains.

9. The box sealing machine capable of automatically detecting adhesive tape as claimed in claim 1, wherein a sensor is fitted on a lateral side of the tape stand for detecting amount of those portions of the tape roll that have not yet been used; alerting signals being going to be sent out when amount of spare portions of the tape roll drops to a predetermined value.

10. The box sealing machine capable of automatically detecting adhesive tape as claimed in claim 1, wherein the responding element includes a plurality of plate parts, which are circumferentially spaced around and joined to the first supporting roller.

11. The box sealing machine capable of automatically detecting adhesive tape as claimed in claim 1, wherein the bed has a conveying belt assembly fitted thereto, which includes two opposed seat parts, a plurality of rolling wheels fitted to each of the seat parts, and a conveying belt passed around the rolling wheels of each conveying seat; the seat parts being capable of being moved to adjust width of a space between them to suit goods to be conveyed; the conveying belt assembly being equipped with plural sleeves on a lower side, which are joined to the seat parts, and which are each joined to a threaded rod, such that width of the space between the seat parts can be adjusted by means of turning the threaded rod; a width meter being fitted to one end of the threaded rod for showing width of the space between the seat parts; a manual adjusting wheel being fitted to said end of the threaded rod for manually turning the threaded rod.

12. The box sealing machine capable of automatically detecting adhesive tape as claimed in claim 1, wherein the bed has a switch fitted thereto, which is used for turning on/off the telescopic lifting device of the supporting member; the tape applying mechanism will function completely automatically when the telescopic lifting device is turned on; the tape applying mechanism will function semi-automatically when the telescopic lifting device is turned off.

13. A box sealing machine capable of automatically detecting adhesive tape, comprising
a bed;
a conveying platform on the bed for conveying goods;
a supporting member joined to the bed and adjustable in height;
a tape applying mechanism fitted on the supporting member; the tape applying mechanism including a tape stand, a tape roll supported on the tape stand, a cutter for severing the tape, and a plurality of supporting rollers, over which a free section of the tape roll is passed; at least one of the supporting rollers having a responding element fitted thereon; the tape stand having a sensor fitted on a lateral side thereof for detecting amount of those portions of the tape roll that have not yet been used; alerting signals being going to be sent out when amount of spare portions of the tape roll drops to a predetermined value;
a response detecting device for sensing the responding element to monitor rotation of the supporting rollers, thus calculating number of circles the supporting rollers are turned when a section of tape is being fed from the tape roll and causing the supporting rollers to turn; the responding element includes a plurality of plate parts, which are circumferentially spaced around and joined to the first supporting roller;
the supporting member including a lifting device securely joined to the bed at one end, an up and down movable unit joined to other end of the lifting device, and an inverted U shaped unit having a substantially inverted U shaped section; the inverted U shaped unit being fitted on the up and down movable unit; the inverted U shaped unit having plural co-turning threaded rods fitted thereto; the co-turning threaded rods being capable of being turned for moving the inverted U shaped unit relative to the up and down movable unit;
the conveying platform having front and rear detecting devices at front and rear ends thereof for sensing goods when goods are passed into and out of it;
the tape applying mechanism being equipped with a sensing switch at one end for finding out height of goods; the sensing switch detecting height of goods when the goods are passed by and sensed with the front detecting device, thus allowing the up and down movable unit to stop at such a height as to allow a tape to be applied onto the goods;
the bed having a switch fitted thereto for turning on/off the telescopic lifting device of the supporting member; the tape applying mechanism will function completely automatically when the telescopic lifting device is turned on; the tape applying mechanism will function semi-automatically when the telescopic lifting device is turned off.

14. The box sealing machine capable of automatically detecting adhesive tape as claimed in claim 13, wherein the front and the rear detecting devices are respectively positioned on inverted U shaped rails so as to be movable forwards and rearwards and adjustable in position.

15. The box sealing machine capable of automatically detecting adhesive tape as claimed in claim 13, wherein the co-turning threaded rods are fitted to two lateral sides of the inverted U shaped unit, and a manual height adjusting wheel is joined to an upper end of a first one of the two co-turning threaded rods, and a height meter is joined to a lower side of the manual height adjusting wheel for showing height of the inverted U shaped unit; rotation of the first co-turning threaded rods being going to cause rotation of other co-turning threaded rods.

16. The box sealing machine capable of automatically detecting adhesive tape as claimed in claim 13, wherein the bed has a conveying belt assembly fitted thereto, which includes two opposed seat parts, a plurality of rolling wheels fitted to each of the seat parts, and a conveying belt passed around the rolling wheels of each conveying seat; the seat parts being capable of being moved to adjust width of a space between them to suit goods to be conveyed; the conveying belt assembly being equipped with plural sleeves on a lower side, which are joined to the seat parts, and which are each joined to a threaded rod, such that width of the space between the seat parts can be adjusted by means of turning the threaded rod; a width meter being fitted to one end of the threaded rod for showing width of the space between the seat parts; a manual adjusting wheel being fitted to said end of the threaded rod for manually turning the threaded rod.

17. The box sealing machine capable of automatically detecting adhesive tape as claimed in claim 13, wherein the lifting device is telescopic and actuated by means of pneumatic pressure.

18. The box sealing machine capable of automatically detecting adhesive tape as claimed in claim 13, wherein the lifting device is telescopic, and actuated by means of oil hydraulic pressure.

19. The box sealing machine capable of automatically detecting adhesive tape as claimed in claim 13, wherein the lifting device includes racks and gear set engaging the racks.

20. The box sealing machine capable of automatically detecting adhesive tape as claimed in claim 13, wherein the lifting device includes chains and transmission gears engaging the chains.
